(19) United States
(12) Patent Application Publication
(10) Pub. No.: US 2026/0141925 A1
(43) Pub. Date: May 21, 2026

(54) DAMPING STRUCTURE AND ELECTRONIC DEVICE

(71) Applicants: INVENTEC (PUDONG) TECHNOLOGY CORPORATION, Shanghai (CN); INVENTEC CORPORATION, Taipei City (TW)

(72) Inventors: Hsin-Haou HUANG, Taipei City (TW); Pin-Chieh CHEN, Taipei City (TW); Po-Hsiu CHEN, Taipei City (TW); Hsieh-Liang TSAI, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/228,385

(22) Filed: Jun. 4, 2025

(30) Foreign Application Priority Data
Nov. 20, 2024 (CN) 202411669323.X

(51) Int. Cl. G11B 33/12

(52) U.S. Cl. CPC G11B 33/127

(57) ABSTRACT

An electronic device includes a chassis, a hard disk drive, at least one fan and at least one damping structure. The hard disk drive is disposed in the chassis. The at least one fan is disposed in the chassis. The at least one damping structure is located between the hard disk drive and the at least one fan, and includes at least one fixed base, at least one first mass block, at least one second mass block and at least one cantilever. The at least one fixed base is disposed in the chassis. An end of the at least one first mass block is disposed on the at least one fixed base. The at least one cantilever is connected to another end of the at least one first mass block and an end of the at least one second mass block.

### CROSS-REFERENCE TO RELATED APPLICATIONS

This non-provisional application claims priority under 35 U.S.C. § 119(a) on Patent Application No(s). 202411669323.X filed in China, on Nov. 20, 2024, the entire contents of which are hereby incorporated by reference.

### BACKGROUND OF THE INVENTION

### Technical Field of the Invention

The invention relates to a damping structure and an electronic device, more particularly to a damping structure and an electronic device including a fixed base, multiple mass blocks and a cantilever.

### Description of the Related Art

With the rapid development of technology, the computation performance of processors of an electronic product is improved significantly, while a large amount of heat is generated thereby at the same time. In order to prevent the damage to the processors caused by such heat, a fan is generally provided in the electronic product to cool the processors, so that the processors can operate within an adequate temperature range.

The fan operating in a high speed may generate vibration. When such vibration is transferred to a hard disk drive disposed in the electronic product, a position error signals (PES) may be caused in the operating hard disk drive, thereby adversely affecting an accuracy of data reading and causing a poor read speed of the hard disk drive, for example, causing a low input/output per second (IOPS). Accordingly, an overall performance of the electronic product may be degraded, and data loss may even be caused. Thus, a vibration suppression is critical in the field of the electronic product. Generally, manufactures may additionally assemble a damping member in a chassis of the electronic product to absorb the vibration generated by the fan. However, the conventional damping member is expensive. In addition, it is hard to assemble the damping member in the chassis due to excessive components of the damping member and limited inner space of the chassis. Moreover, the conventional damping member cannot be compatible with different specifications of the chassis. That is, the manufactures need to adopt different sizes of the damping member for different specifications of the chassis, thereby increasing an assembly cost of the damping member. Therefore, lowering the assembly cost while maintaining the damping effect of the damping member is one of the key issues that researchers need to address.

### SUMMARY OF THE INVENTION

The invention provides a damping structure and an electronic device in order to lower the assembly cost while maintaining the damping effect of the damping structure.

One embodiment of the invention provides a damping structure configured to be disposed in a chassis. The damping structure includes at least one fixed base, at least one first mass block, at least one second mass block and at least one cantilever. The at least one fixed base is configured to be disposed in the chassis. An end of the at least one first mass block is disposed on the at least one fixed base. The at least one cantilever is connected to another end of the at least one first mass block and an end of the at least one second mass block.

Another embodiment of the invention provides an electronic device including a chassis, a hard disk drive, at least one fan and at least one damping structure. The hard disk drive is disposed in the chassis. The at least one fan is disposed in the chassis. The at least one damping structure is located between the hard disk drive and the at least one fan, and includes at least one fixed base, at least one first mass block, at least one second mass block and at least one cantilever. The at least one fixed base is disposed in the chassis. An end of the at least one first mass block is disposed on the at least one fixed base. The at least one cantilever is connected to another end of the at least one first mass block and an end of the at least one second mass block.

According to the damping structure and the electronic device disclosed in the above embodiment, an end of the at least one first mass block is disposed on the at least one fixed base. The at least one cantilever is connected to an end of the at least one first mass block and the at least one second mass block. The natural frequency of the damping structure can be correspondingly adjusted by adjusting the mass of the at least one first mass block or the at least one mass block. Therefore, the vibrations can be damped by the damping structure of the electronic device effectively under different operating conditions. When the natural frequency of the damping structure matches a vibration frequency of the at least one fan, a resonance will be generated, and the strong amplitude enhancement effect may be generated by the damping structure. The interaction between the vibration generated by the at least one fan during operation and the at least one cantilever of the damping structure can be conducted along the path in which the vibration is transferred. Specifically, the vibration generated by the at least one fan during operation may be transferred to the at least one cantilever of the damping structure. The at least one cantilever can absorb the vibration effectively, and convert the vibration into kinetic energy of the flexible film. Accordingly, the vibration generated by the at least one fan during operation can be confined within the damping structure to dissipate energy. In addition, the damping structure can be facilitated to be assembled in the limited space between the hard disk drive and the at least one fan and be prevented from interfering with other obstructions disposed in the aforementioned space, and thus, the damping structure can be adaptable to different specifications of the chassis. Accordingly, the assembly cost of the damping structure can be lowered while maintaining the damping effect of the damping structure.

### BRIEF DESCRIPTION OF THE DRAWINGS

The invention will become more fully understood from the detailed description given herein below and the accompanying drawings which are given by way of illustration only and thus are not limitative of the invention and wherein:

FIG. 1 is a plane view of an electronic device in accordance with an embodiment of the invention;

FIG. 2 is a perspective view of one of damping structures of the electronic device in FIG. 1;

FIG. 3 is an exploded view of one of the damping structures of the electronic device in FIG. 2;

FIG. 4 is a top view of one of the damping structures of the electronic device in FIG. 2;

FIG. 5 is a side view of one of the damping structures of the electronic device in FIG. 2; and

FIG. 6 is another side view of one of the damping structures of the electronic device in FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the invention, such as technical and scientific terms, have its own meanings and can be comprehended by those skilled in the art, unless the terms are additionally defined in the invention. That is, the terms used in the following paragraphs should be read on the meaning commonly used in the related fields and will not be overly explained, unless the terms have a specific meaning in the invention.

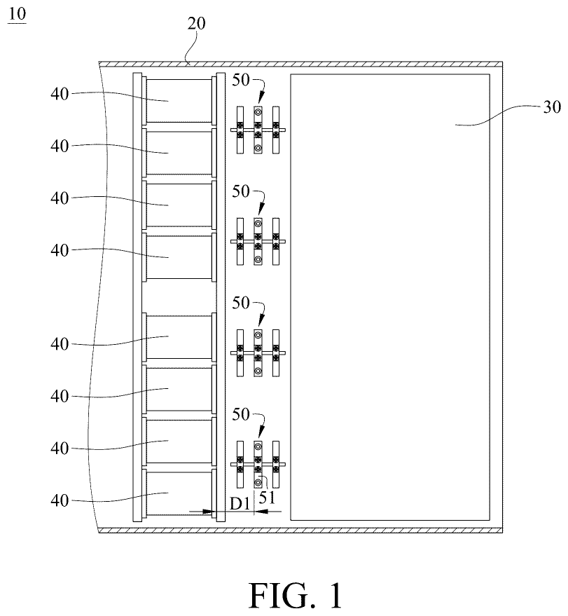

Please refer to FIG. 1, which is a plane view of an electronic device 10 in accordance with an embodiment of the invention. In this embodiment, the electronic device 10 includes a chassis 20, a hard disk drive 30, a plurality of fans 40 and a plurality of damping structures 50. The hard disk drive 30 and the fans 40 are disposed in the chassis 20. The damping structures 50 are disposed between the hard disk drive 30 and the fans 40 as local resonators, such that an interaction between vibrations generated by the fans 40 during operation and the damping structures 50 can be conducted along a path where the vibrations are transferred. Therefore, the vibrations generated by the fans 40 during operation and transferred to the hard disk drive 30 can be damped. Accordingly, the read speed of the hard disk drive 30, such as input/output per second (IOPS) of the hard disk drive 30, is prevented from being reduced by the vibrations.

When a frequency of external vibrations is nearly equal to a resonant frequency of the damping structures 50, a local resonance of the local resonators can be induced to form a vibration bandgap. The local resonance is caused by the interaction between a mass component and elastic waves generated by elastic members of the local resonators, thereby enhancing the vibration suppression effect. In addition, the vibrations of a frequency ranging from, for example, 300 hertz (Hz) to 310 Hz and 365 Hz to 375 Hz can be absorbed by the damping structures 50. That is, the damping structures 50 can generate a resonance to absorb the vibrations generated by the fans 40 during operation within the two aforementioned frequencies.

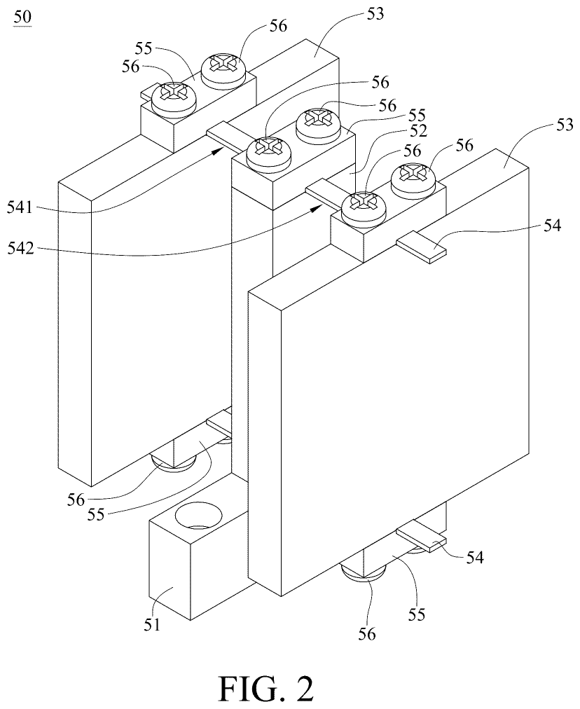

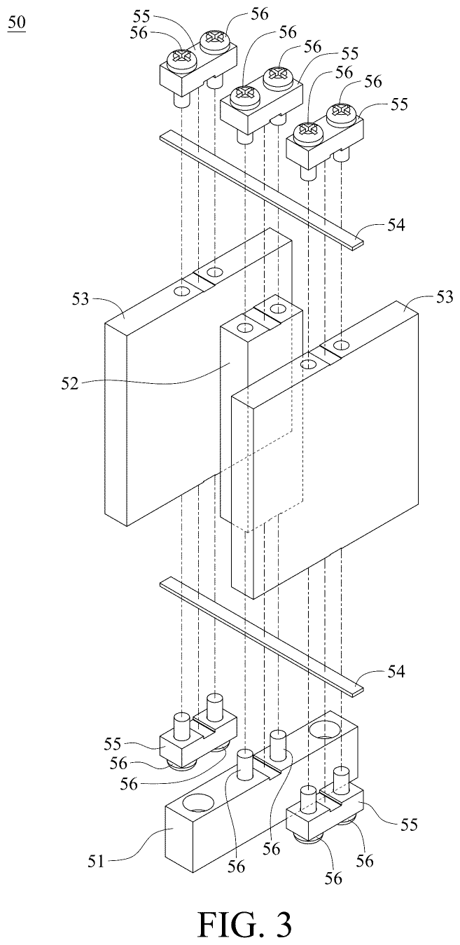

Please refer to FIG. 1 to FIG. 3, where FIG. 2 is a perspective view of one of the damping structures 50 of the electronic device 10 in FIG. 1, and FIG. 3 is an exploded view of one of the damping structures 50 of the electronic device 10 in FIG. 2.

Each of the damping structures 50 includes a fixed base 51, a first mass block 52, two second mass blocks 53, two cantilevers 54, a plurality of assembling members 55 and a plurality of fasteners 56.

The fixed base 51 is disposed in the chassis 20. The first mass block 52 is located between the second mass blocks 53. A mass of one of the second mass blocks 53 is, for example, equal to a mass of another second mass block 53.

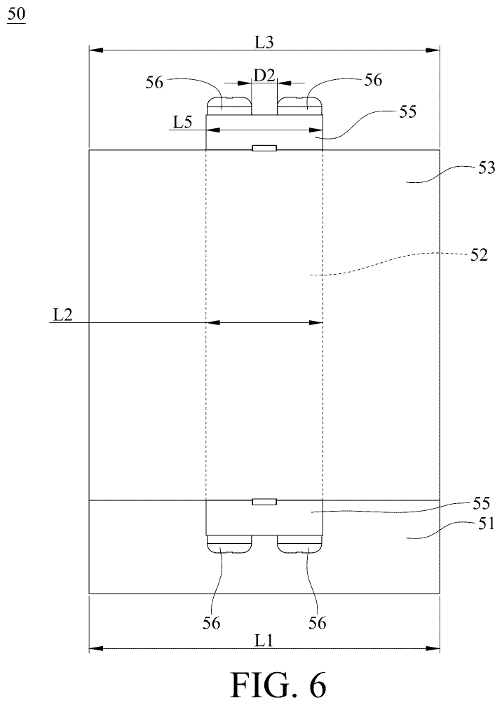

The cantilevers 54 are flexible, and are connected to two opposite ends of the first mass block 52 and the second mass blocks 53, respectively. Each of the cantilevers 54 may further include a first exposed portion 541 and a second exposed portion 542 respectively located between the first mass block 52 and the second mass blocks 53. The first exposed portion 541 refers to a portion of the cantilever 54 which is exposed between the first mass block 52 and one of the second mass blocks 53. The second exposed portion 542 refers to another portion of the cantilever 54 which is exposed between the first mass block 52 and another second mass block 53. That is, the fixed base 51, the first mass block 52, the second mass blocks 53 and the first exposed portion 541 and the second exposed portion 542 of the cantilevers 54 together form a resonator, and a natural frequency of the resonator follows the equation:

$$f = \frac{1}{2 π} \sqrt{\frac{k}{m}} ,$$

where the symbol “f” in the aforementioned equation refers to the natural frequency (unit: hertz, Hz) of the resonator, the symbol “k” in the aforementioned equation refers to a stiffness (unit: newtons per meter, N/m) of the first exposed portion 541 and the second exposed portion 542, and the symbol “m” in the aforementioned equation refers to a total mass (unit: kilograms, kg) of the first mass block 52 and the second mass blocks 53. Furthermore, the stiffness of the first exposed portion 541 and the second exposed portion 542 is inversely proportional to lengths L6 and L7 thereof (shown in FIG. 6 and FIG. 7). That is, the longer the lengths L6 and L7 of the first exposed portion 541 and the second exposed portion 542 are, the lower the stiffness thereof is, and thus, the lower the natural frequency of the resonator is, such that the damping capability of the damping structures 50 is improved. In addition, the greater the total mass of the first mass block 52 and the second mass blocks 53 is, the lower the natural frequency of the resonator is, such that the damping capability of the damping structures 50 is improved. Moreover, the damping structures 50 can absorb the vibrations transferred along a horizontal direction perpendicular to a normal direction of a surface facing away from the fixed base 51, while the second mass blocks 53 not disposed on the fixed base 51 can swing along a vertical direction parallel to the normal direction of the surface facing away from the fixed base 51 via the cantilevers 54 to absorb the vibrations transferred along the aforementioned vertical direction.

One of the cantilevers 54 is at least partially clamped between the fixed base 51 and the first mass block 52. In addition, the first mass block 52 and the second mass blocks 53 with the masses corresponding to an actual vibration frequency may be adopted, and the cantilevers 54 with the lengths corresponding to the actual vibration frequency may be adopted. In the preferred embodiment, for example, weights of the second mass blocks 53 respectively located at opposite ends of the first mass block 52 may be 29 grams, and the length of portion of each of the cantilevers 54 located between the first mass block 52 and each of the second mass blocks 53 may be 11.5 millimeters. Under this condition, the natural frequency of the damping structures 50 can be correspondingly adjusted to, for example, 350 Hz. However, the invention is not limited thereto. In other embodiments, for example, the natural frequency of the damping structures 50 may be reduced to be less than 350 Hz by increasing the weights of the second mass blocks 53. Alternatively, for example, the natural frequency of the damping structures 50 may be increased to be greater than 350 Hz by shortening the lengths of the first exposed portion 541 and the second exposed portion 542 respectively located between the first mass block 52 and the second mass blocks 53 to be less than 11.5 mm.

The assembling members 55 are disposed on the first mass block 52 and the second mass blocks 53, respectively, and hold the cantilevers 54 in position on the first mass block 52 and the second mass blocks 53. The length L6 of the first exposed portion 541 and the length L7 of the second exposed portion 542 can be regarded as a distance between one of the second mass blocks 53 and the first mass block 52 and a distance between another second mass block 53 and the first mass block 52, respectively. In addition, for example, the mass of one of the second mass blocks 53 is equal to the mass of another second mass block 53, and the distance between one of the second mass blocks 53 and the first mass block 52 is equal to the distance between another second mass block 53 and the first mass block 52 so as to realize a balance of a moment between the second mass blocks 53. However, the invention is not limited thereto. In other embodiments, the mass of one of the two second mass blocks may be different from the mass of another second mass block, and the distance between one of the second mass blocks and the first mass block may be different from the distance between another second mass block and the first mass block so as to realize the balance of the moment between the second mass blocks.

The fasteners 56 are, for example, screws, and some of the fasteners 56 fasten the fixed base 51 and the first mass block 52, and some of the fasteners 56 fasten the assembling members 55, the first mass block 52 and the second mass blocks 53. Accordingly, the cantilevers 54 can be more firmly held in position on the first mass block 52 and the second mass blocks 53. Each of the assembling members 55 are fastened to the first mass block 52 or to one of the second mass blocks 53 via, for example, two of the fasteners 56. In addition, for example, the cantilevers 54 are made of aluminum, and the fixed base 51, the first mass block 52, the second mass blocks 53 and the assembling members 55 are made of stainless steel. Moreover, the fixed base 51 is fixed to the chassis 20 via, for example, fasteners (not shown) such as screws. The fixed base 51 is made of, for example, a magnetic material. A distance D1 between the fixed base 51 made of the magnetic material and the fans 40 is, for example, greater than or equal to 1.5 centimeters and less than or equal to 2 centimeters.

In this embodiment, the end of the first mass block 52 is disposed on the fixed base 51. The cantilevers 54 are connected to two opposite ends of the first mass block 52 and the second mass blocks 53, respectively. The natural frequency of the damping structures 50 can be correspondingly adjusted by adjusting the mass of the first mass block 52 or the two second mass blocks 53. Therefore, the vibrations can be damped by the damping structures 50 of the electronic device 10 effectively under different operating conditions. When the natural frequency of the damping structures 50 matches the vibration frequency of the fans 40, a resonance will be generated, and the strong amplitude enhancement effect may be generated by the damping structures 50. The interaction between the vibrations generated by the fans 40 during operation and the cantilevers 54 of the damping structures 50 can be conducted along the path in which the vibrations are transferred. Specifically, the vibrations generated by the fans 40 during operation may be transferred to the cantilevers 54 of the damping structures 50. The cantilevers 54 can absorb the vibrations effectively, and convert the vibrations into kinetic energy of the cantilevers 54. Accordingly, the vibrations generated by the fans 40 during operation can be confined within the damping structures 50 to dissipate energy. In addition, the damping structures 50 can be facilitated to be assembled in the limited space between the hard disk drive 30 and the fans 40 and be prevented from interfering with other obstructions disposed in the aforementioned space, and thus, the damping structures 50 can be adaptable to different specifications of the chassis 20. Accordingly, the assembly cost of the damping structures 50 can be lowered while maintaining the damping effect of the damping structures 50.

In this embodiment, there are multiple fans 40 and multiple damping structures 50, but the invention is not limited thereto. In other embodiments, there may be one fan and one damping structure merely.

In this embodiment, there are one fixed base 51 and one first mass block 52 merely, there are two second mass blocks 53, and the first mass block 52 is located between the second mass blocks 53, but the invention is not limited thereto. In other embodiments, there may be two fixed bases and two first mass blocks, there may be one second mass block merely, and the second mass block is located between the first mass blocks. Alternatively, there may be one fixed base, one first mass block and one second mass block.

In this embodiment, there are two cantilevers 54 in each of the damping structures 50, and the cantilevers 54 are connected to two opposite ends of the first mass block 52 and the second mass blocks 53, respectively, but the invention is not limited thereto. In other embodiments, there may be one cantilever in each of the damping structures merely, and the cantilever is connected to an end of the first mass block and an end of the second mass blocks. Alternatively, there are three cantilevers in each of the damping structures, and the cantilevers are connected to two opposite ends of the first mass block and the second mass blocks, respectively.

In this embodiment, the mass of one of the second mass blocks 53 is equal to the mass of another second mass block 53, but the invention is not limited thereto. In other embodiments, the mass of one of the second mass blocks may be different from the mass of another second mass block.

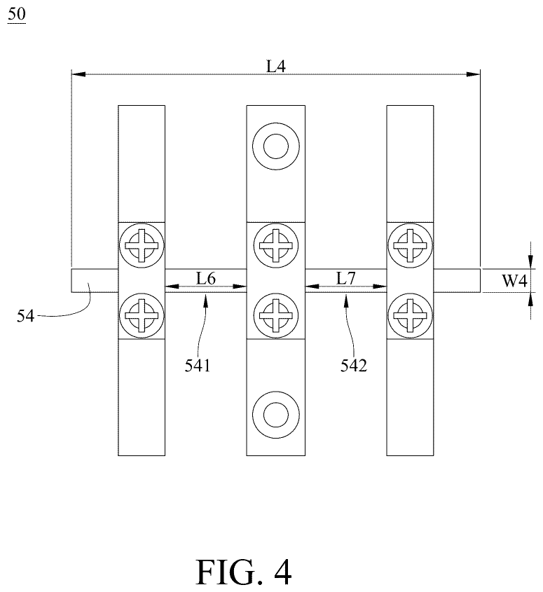

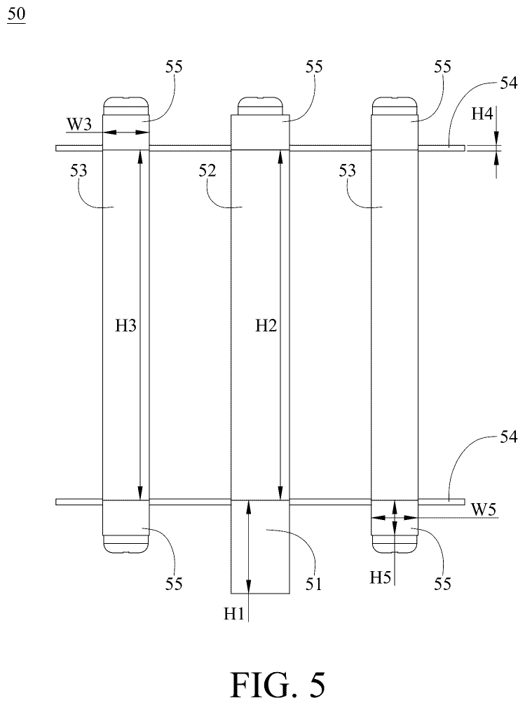

Please refer to FIG. 4 to FIG. 6, where FIG. 4 is a top view of one of the damping structures 50 of the electronic device 10 in FIG. 2, FIG. 5 is a side view of one of the damping structures 50 of the electronic device 10 in FIG. 2, and FIG. 6 is another side view of one of the damping structures 50 of the electronic device 10 in FIG. 2.

In this embodiment, a ratio of a length L1 of the fixed base 51 to a height H1 of the fixed base 51 is, for example, greater than or equal to 3.3 and less than or equal to 3.9. For example, the length L1 of the fixed base 51 may be greater than or equal to 29 millimeters and less than or equal to 31 millimeters.

In this embodiment, a length L2 of the first mass block 52 is, for example, equal to a length L3 of each of the second mass blocks 53. A height H2 of the first mass block 52 is, for example, equal to a height H3 of each of the second mass blocks 53. A ratio of the length L3 of each of the second mass blocks 53 to a width W3 of each of the second mass blocks 53 is, for example, greater than or equal to 7.2 and less than or equal to 7.8. A ratio of the length L3 of each of the second mass blocks 53 to the height H3 of each of the second mass blocks 53 is, for example, greater than or equal to 0.7 and less than or equal to 1.3. For example, the length L2 of the first mass block 52 and the length L3 of each of the second mass blocks 53 may be greater than or equal to 29 millimeters and less than or equal to 31 millimeters.

In this embodiment, a ratio of a length L4 of each of the cantilevers 54 to a width W4 of each of the cantilevers 54 is, for example, greater than or equal to 17.3 and less than or equal to 17.9. A ratio of a width W4 of each of the cantilevers 54 to a height H4 of each of the cantilevers 54 is, for example, greater than or equal to 3.7 and less than or equal to 4.3. For example, the length L4 of each of the cantilevers 54 may be greater than or equal to 34 millimeters and less than or equal to 36 millimeters.

In this embodiment, a ratio of a length L5 of each of the assembling members 55 to a width W5 of each of the assembling members 55 disposed on the second mass blocks 53 is, for example, greater than or equal to 2.2 and less than or equal to 2.8. A ratio of the length L5 of each of the assembling members 55 to a height H5 of each of the assembling members 55 disposed on the second mass blocks 53 is, for example, greater than or equal to 3 and less than or equal to 3.6. A ratio of the length L5 of each of the assembling members 55 to a distance D2 between the two of the fasteners 56 disposed on each of the assembling members 55 is, for example, greater than or equal to 4.7 and less than or equal to 5.3. For example, the length L5 of each of the assembling members 55 may be greater than or equal to 9 millimeters and less than or equal to 11 millimeters.

According to the damping structure and the electronic device disclosed in the above embodiment, the end of the first mass block is disposed on the fixed base. The cantilevers are connected to two opposite ends of the first mass block and the second mass blocks, respectively. The natural frequency of the damping structures can be correspondingly adjusted by adjusting the mass of the first mass block or the two second mass blocks. Therefore, the vibrations can be damped by the damping structures of the electronic device effectively under different operating conditions. When the natural frequency of the damping structures matches the vibration frequency of the fans, a resonance will be generated, and the strong amplitude enhancement effect may be generated by the damping structures. The interaction between the vibrations generated by the fans during operation and the cantilevers of the damping structures can be conducted along the path in which the vibrations are transferred. Specifically, the vibrations generated by the fans during operation may be transferred to the cantilevers of the damping structures. The cantilevers can absorb the vibrations effectively, and convert the vibrations into kinetic energy of the flexible film. Accordingly, the vibrations generated by the fans during operation can be confined within the damping structures to dissipate energy. In addition, the damping structures can be facilitated to be assembled in the limited space between the hard disk drive and the fans and be prevented from interfering with other obstructions disposed in the aforementioned space, and thus, the damping structures can be adaptable to different specifications of the chassis. Accordingly, the assembly cost of the damping structures can be lowered while maintaining the damping effect of the damping structures.

In this embodiment, the damping structures of the invention can be applied to a server. The server can apply artificial intelligence (AI) computing, edge computing, and can also be used as a 5G server, a cloud server or a Vehicle-to-everything server.

It will be apparent to those skilled in the art that various modifications and variations can be made to the invention. It is intended that the specification and examples be considered as exemplary embodiments only, with the scope of the invention being indicated by the following claims.

What is claimed is:

1. A damping structure, configured to be disposed in a chassis and comprising:
at least one fixed base, configured to be disposed in the chassis;
at least one first mass block and at least one second mass block, wherein an end of the at least one first mass block is disposed on the at least one fixed base; and
at least one cantilever, connected to another end of the at least one first mass block and an end of the at least one second mass block.

2. The damping structure according to claim 1, further comprising a plurality of assembling members, wherein the plurality of assembling members are disposed on the at least one first mass block and the at least one second mass block, respectively, and the plurality of assembling members hold the at least one cantilever in position on the at least one first mass block and the at least one second mass block.

3. The damping structure according to claim 2, further comprising a plurality of fasteners, wherein a part of the plurality of fasteners fasten the at least one fixed base and the at least one first mass block, and another part of the plurality of fasteners fasten the plurality of assembling members, the at least one first mass block and the at least one second mass block.

4. The damping structure according to claim 3, wherein a ratio of a length of each of the assembling members to a width of each of the assembling members disposed on the at least one second mass block is greater than or equal to 2.2 and less than or equal to 2.8, a ratio of the length of each of the assembling members to a height of each of the assembling members disposed on the at least one second mass block is greater than or equal to 3 and less than or equal to 3.6, each of the assembling members is fastened to the at least one first mass block or the at least one second mass block via two of the plurality of fasteners, and a ratio of the length of each of the assembling members to a distance between the two of the plurality of fasteners disposed on each of the assembling members is greater than or equal to 4.7 and less than or equal to 5.3.

5. The damping structure according to claim 1, wherein at least one fixed base comprises one fixed base, the at least one first mass block comprises one first mass block, the at least one second mass block comprises two second mass blocks, the first mass block is located between the two second mass blocks, the at least one cantilever comprises a plurality of cantilevers, the plurality of cantilevers are connected to two opposite ends of the first mass block and the two second mass blocks, respectively, and at least one of the plurality of cantilevers is at least partially clamped between the fixed base and the first mass block.

6. The damping structure according to claim 5, wherein a mass of one of the two second mass blocks is equal to a mass of another one of the two second mass blocks, and a distance between one of the two second mass blocks and the first mass block is equal to a distance between another one of the two second mass blocks and the first mass block.

7. The damping structure according to claim 5, wherein a mass of one of the two second mass blocks is different from a mass of another one of the two second mass blocks, and a distance between one of the two second mass blocks and the first mass block is different from a distance between another one of the two second mass blocks and the first mass block.

8. An electronic device, comprising:
a chassis;
a hard disk drive, disposed in the chassis;
at least one fan, disposed in the chassis; and
at least one damping structure, located between the hard disk drive and the at least one fan and comprising:
at least one fixed base, disposed in the chassis;
at least one first mass block and at least one second mass block, wherein an end of the at least one first mass block is disposed on the at least one fixed base; and
at least one cantilever, connected to another end of the at least one first mass block and an end of the at least one second mass block.

9. The electronic device according to claim 8, further comprising a plurality of assembling members and a plurality of fasteners, wherein the plurality of assembling members are disposed on the at least one first mass block and the at least one second mass block, respectively, the plurality of assembling members hold the at least one cantilever in position on the at least one first mass block and the at least one second mass block, and the plurality of fasteners fasten the plurality of assembling members to the at least one first mass block and the at least one second mass block, respectively.

10. The electronic device according to claim 8, wherein the at least one fixed base is made of magnetic material, and a distance between the at least one fixed base and the at least one fan is greater than or equal to 1.5 centimeters and less than or equal to 2 centimeters.
